(19) United States
(12) Patent Application Publication
(10) Pub. No.: US 2008/0311800 A1
(43) Pub. Date: Dec. 18, 2008

(54) Quick-detachable terminal block assembly

(75) Inventor: Shang Tsai Wu, Taipei Hsien (TW)

Correspondence Address: BIRCH STEWART KOLASCH & BIRCH, PO BOX 747, FALLS CHURCH, VA, 22040-0747, US

(73) Assignee: DINKLE ENTERPRISE CO., LTD.

(21) Appl. No.: 11/812,337

(22) Filed: Jun. 18, 2007

(51) Int. Cl. H01R 9/24

(52) U.S. Cl. 439/709

(57) ABSTRACT

Disclosed is a quick-detachable terminal block assembly, which includes a terminal block detachably mounted in a mounting through hole of a circuit board, a plurality of conducting terminals mounted in the terminal block and extending out of the top side of the terminal block, and two metal spring leaves each having rear mounting panel affixed to a respective locating groove at each of two opposite sides of the terminal block and a front clamping panel for locking the terminal block to the circuit board after insertion of the terminal block through the mounting through hole. The front clamping panel has a release tip for pressing by the user to disengage the terminal block from the circuit board.

### BACKGROUND OF THE INVENTION

1. Field of the Invention

The present invention relates generally to terminal blocks and more particularly, to a quick-detachable terminal block assembly, which has two metal spring leaves provided at two sides for locking the terminal block to a circuit board after insertion of the terminal block through a mounting through hole on the circuit board.

2. Description of the Related Art

A terminal block is a small block holding a number of conducting terminals at one side of a circuit board for the bonding of an electric connector or other circuit means.

A conventional terminal block has an upwardly protruding middle part, and mounting holes on the two opposite mounting blocks at two sides of the upwardly protruding middle part. The conducting terminals extend out of the top side of the upwardly protruding middle part. During installation, mounting screws or rivets are mounted in the mounting holes of the terminal block and fastened to respective mounting holes on the circuit board. This mounting procedure is complicated, wasting much time. Further much operation space is needed for the operation of the tool to fasten the screws or rivets. Further, when screws are used, the screws may fall out of place upon vibration during transportation of the product.

There is known another design of terminal block, which has a dovetail groove for coupled to a dovetail tongue at a circuit board. According to this design, the processing of the dovetail groove at the terminal block and the formation of the dovetail tongue at the circuit board is complicated, increasing much the cost.

Therefore, it is desirable to provide a terminal block that eliminates the aforesaid drawbacks.

### SUMMARY OF THE INVENTION

The present invention has been accomplished under the circumstances in view. It is the main object of the present invention to provide a quick-detachable terminal block assembly, which can easily and quickly be installed in a circuit board and locked thereto and, which can easily and quickly be released from its mounting position at the circuit board. It is another object of the present invention to provide a quick-detachable terminal block assembly, which uses metal spring leaves for locking the terminal block to a mounting through hole of a circuit board.

To achieve these and other objects of the present invention, the quick-detachable terminal block assembly comprises a terminal block detachably mounted in a mounting through hole of a circuit board, and a plurality of conducting terminals mounted in the terminal block and extending out of the top side of the terminal block. The terminal block has two mounting blocks disposed at two sides. The mounting blocks each comprise a locating groove at one side, and a metal spring leaf mounted in the locating groove for locking the terminal block to the mounting through hole of the circuit board. The metal spring leaf comprises a U-turn, a rear mounting panel extending from one end of the U-turn and fastened to the locating groove of the associating mounting block, and a front clamping panel extending from an opposite end of the U-turn. The front clamping panel has an oblique protrusion for stopping at the top wall of the circuit board to lock the terminal block to the circuit board after insertion of the terminal block through the mounting through hole, and a release tip extending from the oblique protrusion for pressing by the user to release the oblique protrusion from the top wall of the circuit board for allowing removal of the terminal block from the circuit board.

### BRIEF DESCRIPTION OF THE DRAWINGS

FIG. 1 is an exploded view of a quick-detachable terminal block assembly in accordance with a first embodiment of the present invention.

FIG. 2 is an elevational assembly view of the quick-detachable terminal block assembly in accordance with a first embodiment of the present invention.

FIG. 3 is a schematic drawing showing the mounting procedure of the quick-detachable terminal block assembly in the circuit board according to the first embodiment of the present invention (I).

FIG. 4 is a schematic drawing showing the mounting procedure of the quick-detachable terminal block assembly in the circuit board according to the first embodiment of the present invention (II).

FIG. 5 is a schematic drawing showing the mounting procedure of the quick-detachable terminal block assembly in the circuit board according to the first embodiment of the present invention (III).

FIG. 6 is a schematic drawing showing the dismounting procedure of the quick-detachable terminal block assembly from the circuit board according to the first embodiment of the present invention.

FIG. 7 is a plain view of one metal spring leaf for the quick-detachable terminal block assembly in accordance with the first embodiment of the present invention.

FIG. 8 is an exploded view of a quick-detachable terminal block assembly in accordance with a second embodiment of the present invention.

FIG. 9 is a schematic drawing showing the mounting procedure of the quick-detachable terminal block assembly in the circuit board according to the second embodiment of the present invention

### DETAILED DESCRIPTION OF THE INVENTION

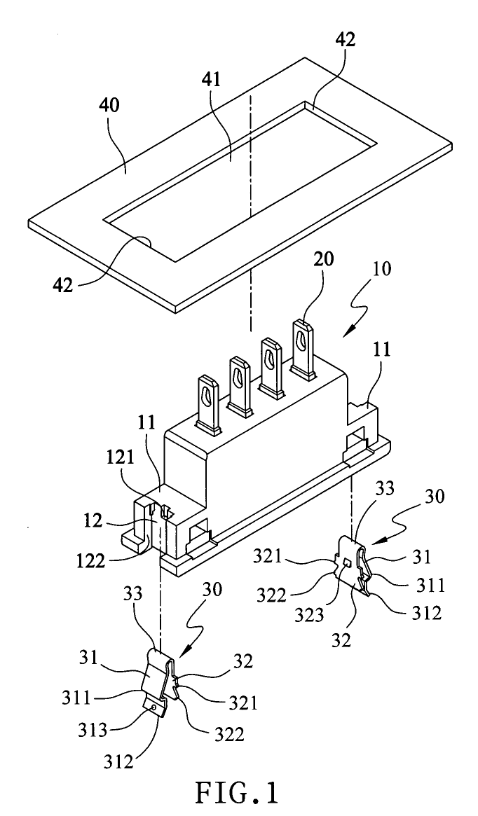

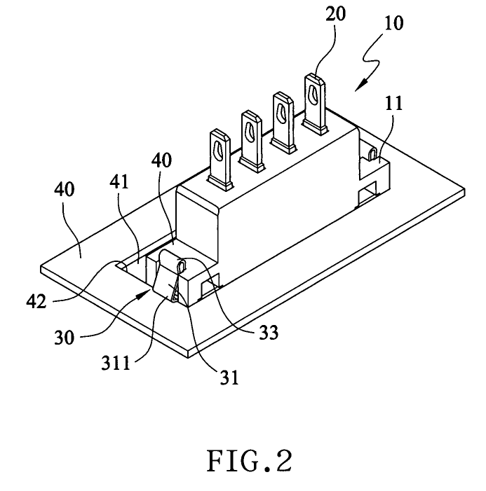

Referring to FIGS. 1, 2, and 5, a quick-detachable terminal block assembly in accordance with the present invention is shown comprising a terminal block 10 and a plurality of metal terminals 20 mounted in the terminal block 10 and partially extending out of the top wall of the terminal block 10. The terminal block 10 has two mounting blocks 12 at two sides, and a locating groove 12 at each of the two mounting blocks and a retaining hole 121 in each locating groove 12. A metal spring leaf 30 is mounted in each locating groove 12 and stopped between two opposite sidewalls 122 of the associating locating groove 12.

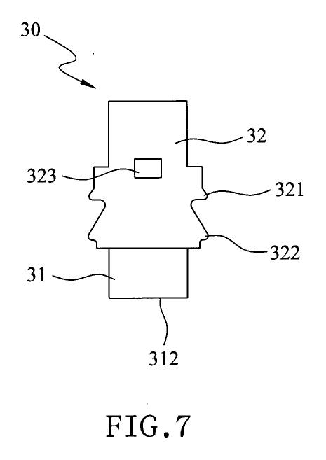

Referring to FIG. 7 and FIGS. 1 and 5 again, the metal spring leaf 30 has a V-shaped profile invertedly mounted in the associating locating groove 12, i.e., the metal spring leaf 30 has a U-turn 33 on the middle, a front clamping panel 31 extending from one end of the U-turn 33, and a rear mounting panel 32 extending from the other end of the U-turn 33. The rear mounting panel 32 has two barbed portions 321 and 322 arranged at different elevations at each of the two opposite lateral side edges for engaging the two opposite sidewalls 122 of the associating locating groove 12, and a retaining protrusion 323 protruding from the outer side for engaging the retaining hole 121 in the associating locating groove 12 to secure the respective metal spring leaf 30 firmly to the associating locating groove 12. The front clamping panel 31 has an oblique protrusion 311 and a release tip 312 extending from the oblique protrusion 311 and curving outwardly upwards. When viewing from one side, the oblique protrusion 311 shows a sharp top side and an expanded bottom side. The oblique protrusion 311 has a raised portion 313 protruding from the center of the outer side of the oblique protrusion 311. A recessed portion may be used to substitute for the raised portion 313 for positioning.

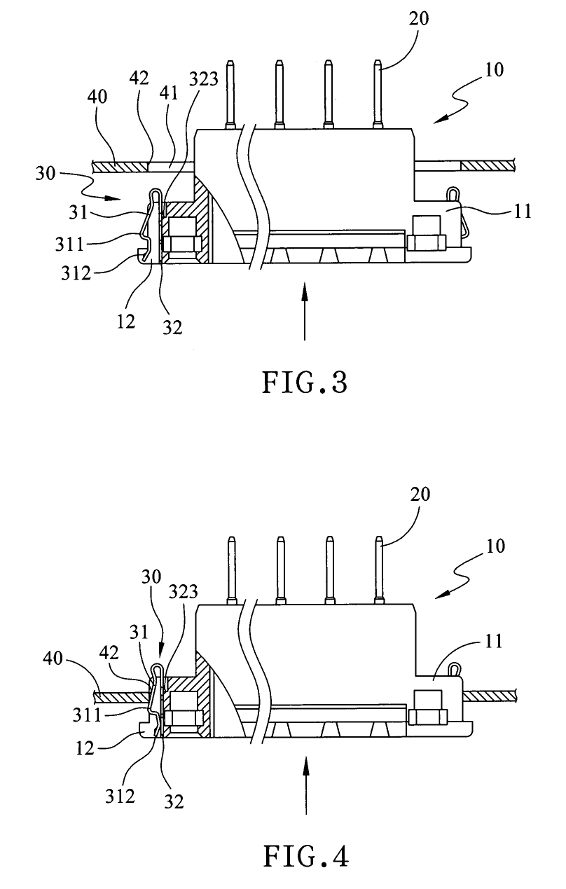

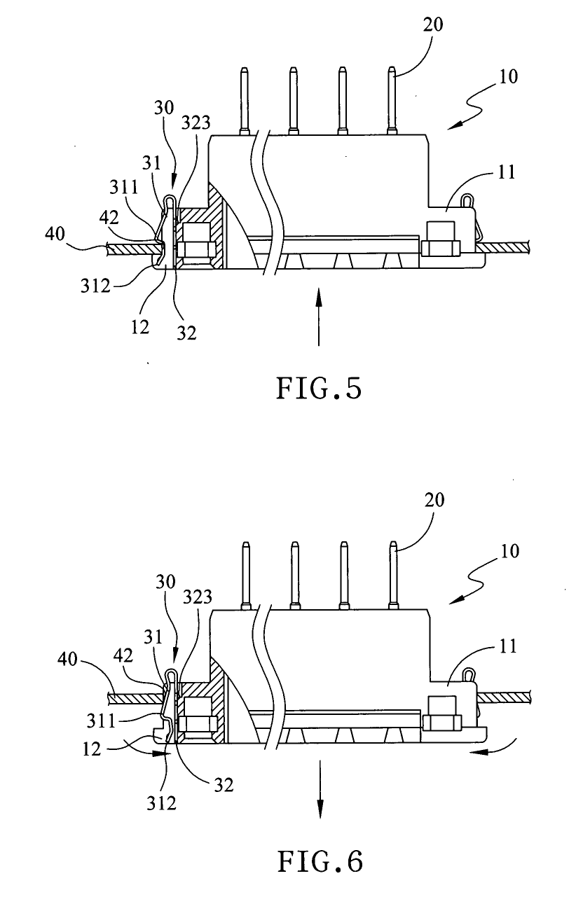

Referring to FIGS. 3 and 4 and FIG. 1 again, the terminal block 10 is inserted through a mounting through hole 41 on a circuit board 40 in direction from the bottom side of the circuit board 40 toward its top side, forcing the front clamping panel 31 of each metal spring leaf 30 against the peripheral edge 42 of the mounting through hole 41 of the circuit board 40. After the oblique protrusion 311 of each metal spring leaf 30 is moved over the peripheral edge 42 of the mounting through hole 41 of the circuit board 40, the metal spring power of the metal spring leaves 30 force the respective oblique protrusions 311 outwards, keeping the oblique protrusions 311 stopped at the top wall of the circuit board 40 and the raised portions 313 stopped at the bottom wall of the circuit board 40, and therefore the terminal block 10 is locked to the circuit board 40 as shown in FIG. 5. When wishing to dismount the terminal block assembly from the circuit board 40, as shown in FIG. 6, press the release tip 312 of each metal spring leaf 30 to disengage the respective oblique protrusions 311 from the top wall of the circuit board 40, and then pull the terminal block 10 downwards, separating the terminal block assembly from the circuit board 40.

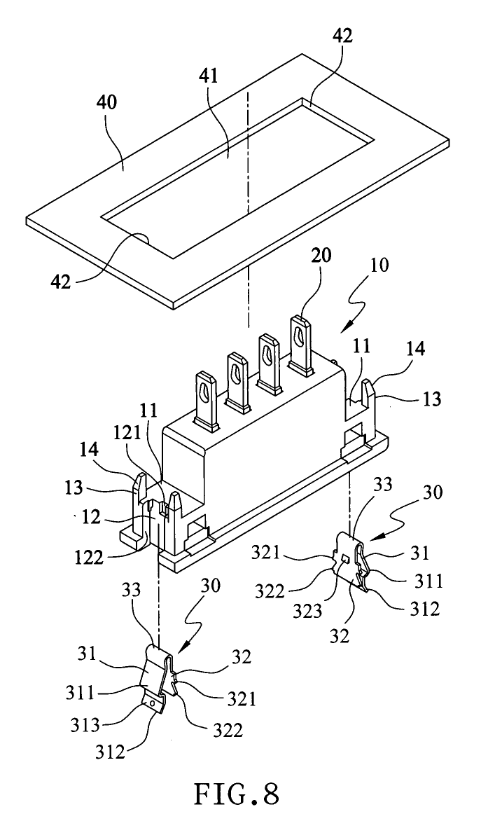

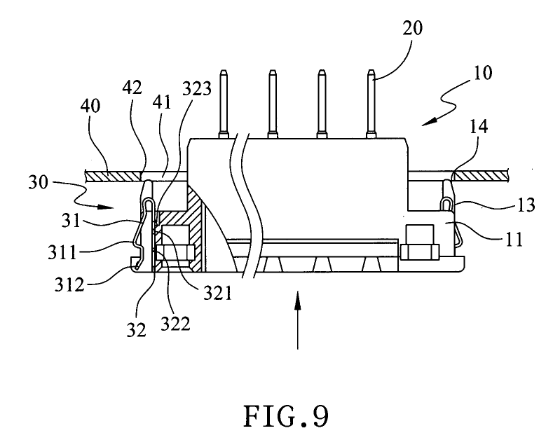

FIGS. 8 and 9 show an alternate form of the present invention. Similar to the aforesaid first embodiment, this second embodiment comprises a terminal block 10, a plurality of metal terminals 20 mounted in the terminal block 10 and partially extending out of the top wall of the terminal block 10, and two metal spring leaves 30 for securing the terminal block 10 to a circuit board 40. The terminal block 10 has a locating groove 12 at each of two opposite sides thereof and a retaining hole 121 in each locating groove 12. The metal spring leaves 30 are respectively mounted in the locating grooves 12 of the terminal block 10 and stopped between the two opposite sidewalls 122 of the respective associating locating grooves 12. The terminal block 10 of this second embodiment further comprises two pairs of upright guide posts 13 arranged in parallel at two sides of each of the locating grooves 12. Each upright guide post 13 has a beveled guide surface 14 for guiding the insertion of the terminal block 10 into the mounting through hole 41 of the circuit board 40. Alternatively, the upright guide posts 13 may be omitted, and the beveled guide surfaces 14 may be directly formed on the top side edges of the terminal block 10 at two sides of each locating groove 12.

As stated above, the detachable terminal block assembly has the following features and advantages:

1. Two metal spring leaves are provided at two opposite sides of the terminal block for locking the terminal block to the circuit board automatically after insertion of the terminal block through the mounting through hole of the circuit board. Pressing the release tips of the metal spring leaves unlock the terminal block from the circuit board, allowing removal of the terminal block from the circuit board.

2. The metal spring leaves do not fall from the terminal block upon vibration during transportation.

3. The metal spring leaves are suitable for mass production to lower the cost.

Further, the structural features of the detachable terminal block assembly can also be employed to the fabrication of other electrical connectors.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A terminal block assembly comprising a terminal block detachably mounted in a mounting through hole of a circuit board, said terminal block having two mounting blocks disposed at two sides, and a plurality of conducting terminals mounted in said terminal block and extending out of a top side of said terminal block, wherein:
said mounting blocks of said terminal block each comprise a locating groove at one side, and a metal spring leaf mounted in said locating groove for locking said terminal block to the mounting through hole of said circuit board, said metal spring leaf comprising a U-turn, a rear mounting panel extending from one end of said U-turn and fastened to the locating groove of the associating mounting block, and a front clamping panel extending from an opposite end of said U-turn, said front clamping panel having an oblique protrusion for stopping at a top wall of said circuit board to lock said terminal block to said circuit board after insertion of said terminal block through said mounting through hole, and a release tip extending from said oblique protrusion for pressing by the user to release said oblique protrusion from the top wall of said circuit board for allowing removal of said terminal block from said circuit board.

2. The terminal block assembly as claimed in claim 1, wherein said mounting blocks of said terminal block each further comprise a retaining hole in the respective locating groove for securing the rear mounting panels of said metal spring leaves.

3. The terminal block assembly as claimed in claim 2, wherein the rear mounting panels of said metal spring leaves each have a retaining protrusion for engaging the retaining holes in said locating grooves of said mounting blocks.

4. The terminal block assembly as claimed in claim 1, wherein said oblique protrusion has a sharp top side and an expanded bottom side.

5. The terminal block assembly as claimed in claim 1, wherein said release tip of said front clamping panel curves outwardly upwards.

6. The terminal block assembly as claimed in claim 1, wherein said release tip of said front clamping panel has a raised portion for stopping at a bottom wall of said circuit board.

7. The terminal block assembly as claimed in claim 1, wherein said mounting blocks each have a plurality of beveled guide surfaces disposed at two sides relative to said locating grooves at an elevation above said locating grooves for guiding insertion of said terminal block into the mounting through hole of said circuit board.

8. The terminal block assembly as claimed in claim 1, wherein said mounting blocks each comprise a plurality of upright guide posts arranged at two sides relative to said locating grooves at an elevation above said locating grooves, said upright guide posts each having a beveled guide surface for guiding insertion of said terminal block into the mounting through hole of said circuit board.

9. A terminal block assembly comprising a terminal block detachably mounted in a mounting through hole of a circuit board, said terminal block having two mounting blocks disposed at two sides, and a plurality of conducting terminals mounted in said terminal block and extending out of a top side of said terminal block, wherein:
said mounting blocks of said terminal block each comprise two locating grooves disposed at two opposite sides, and two metal spring leaves respectively mounted in said locating grooves for locking said terminal block to the mounting through hole of said circuit board, said metal spring leaves each comprising a U-turn, a rear mounting panel extending from one end of said U-turn and fastened to the associating locating groove, and a front clamping panel extending from an opposite end of said U-turn, said front clamping panel having an oblique protrusion for stopping at a top wall of said circuit board to lock said terminal block to said circuit board after insertion of said terminal block through said mounting through hole, and a release tip extending from said oblique protrusion for pressing by the user to release said oblique protrusion from the top wall of said circuit board for allowing removal of said terminal block from said circuit board.
